(19) United States
(12) Patent Application Publication
(10) Pub. No.: US 2009/0197021 A1
(43) Pub. Date: Aug. 6, 2009

(54) Systems and Methods for Providing an Improved Artificial Grass System

(75) Inventors: David Michael Jones, Dacula, GA (US); Kevin Nelson King, Alto, GA (US); Robert Peter Rossing, Dubai (AE)

Correspondence Address: THE WEBB LAW FIRM, P.C., 700 KOPPERS BUILDING, 436 SEVENTH AVENUE, PITTSBURGH, PA, 15219, US

(73) Assignee: TEN CATE THIOBAC B.V., Nijverdal (NL)

(21) Appl. No.: 12/302,961

(22) PCT Filed: Jun. 1, 2007
(86) PCT No.: PCT/EP2007/004892

§ 371 Date: Apr. 15, 2009

Related U.S. Application Data
(60) Provisional application No. 60/810,784, filed on Jun. 2, 2006.

(51) Int. Cl. A41G 1/00; B32B 5/26; B29C 61/02

(52) U.S. Cl. 428/17; 442/241; 264/239

(57) ABSTRACT

Embodiments of the invention can provide systems and methods for providing an artificial grass system. One embodiment of the invention can provide an artificial grass system with a woven tubular-shaped fabric and tufted artificial turf yarn. For example, the woven tubular-shaped fabric can be made from at least two types of yarn with different shrink characteristics. Various embodiments of the invention can provide improved drainage, shock absorbency, load displacement, and dimensional stability characteristics for an artificial grass or turf system.

### FIELD OF INVENTION

The invention generally relates to artificial grass and turf. More specifically, the invention relates systems and methods for providing an artificial grass system.

### BACKGROUND OF THE INVENTION

Conventional artificial grass or turf systems are used in landscaping, carpeting, and athletic playing field applications. Generally, artificial grass or turf systems can include artificial grass attached to a substrate installed above multiple layers of artificial and/or natural materials to provide desired impact and/or resiliency characteristics. For instance, conventional artificial grass or turf systems can include artificial grass tufted into one or several woven and/or nonwoven layers. The tufted artificial grass material can be mounted over multiple layers of material. The layers may include, for example, a drainage layer, a separation layer, and a shock-absorbing layer. In another example, many conventional artificial turf systems require both a primary backing or substrate for the pile or face yarns to be tufted into and a sub-base to provide desired shock absorbency and energy restitution characteristics for the artificial turf system. For example, U.S. Pat. No. 6,221,445 relates to an artificial turf system with several layers, including shock absorbing and drainage layers, and a main layer with a plastic geo cell filled with a shock absorbing material. A tufted artificial grass material can be separately installed on top of the geo cells.

Conventional third generation-type artificial turf systems, such as rubber in-fill systems, can utilize relatively long (40-60 millimeter) face yarns tufted into a substrate and filler materials such as a sand, rubber, EPDM (Ethylene Propylene Diene Monomer), TPE (Thermo Plastic Elastomer) or other suitable plastomer granulates to provide desired characteristics for the artificial turf system. However, such systems can require use of relatively large amounts of rubber, EPDM, TPE or other plastomers, thereby increasing the overall costs of such artificial turf systems.

Some or all of the conventional artificial turf systems described above may have tufted yarns that are not relatively upright with respect to the substrate, and additional effort and materials may be needed to apply sand, rubber, EPDM, TPE or other plastomer granulates between the tufted yarns to prop up or otherwise support the tufted yarns with respect to the substrate. The labor and material expenditure to apply such materials to conventional artificial turf systems can also increase the overall costs of such artificial turf systems.

One measure of impact and/or resiliency characteristics for artificial turf systems can be determined by the G-Max test. This test can be performed on artificial surfaces and can measure the impact force or absorbance of an artificial grass or turf system, and can measure the shock attenuation or hardness of a surface. Another method for determining these properties is the use of “The Artificial Athlete” as described in the FIFA quality concept “Handbook of Test methods for Football Turf” (March 2006 edition). This test is performed by an apparatus which can measure the impact force, shock absorption and/or energy restitution.

Tests indicate that when conventional artificial grass or turf systems and associated surfaces are subject to repeated impact forces over time, such systems can compact, thereby increasing the hardness of the associated surface.

Accordingly, a need exists for systems and methods for providing an artificial grass system with improved drainage, shock absorbency, load displacement, energy restitution and dimensional stability. In addition, a need exists for an artificial grass system capable of providing improved drainage, shock absorbency, load displacement, energy restitution and dimensional stability. Furthermore, a need exists for an artificial grass system that utilizes relatively less rubber, EPDM, TPE or plastomers than conventional artificial grass systems such as rubber in-fill systems.

### SUMMARY OF THE INVENTION

Unless otherwise stated, terms used herein such as “top,” “bottom,” “upper,” “lower,” “left,” “right,” “front,” “back,” and the like are used only for convenience of description and are not intended to limit the invention to any particular orientation.

Furthermore, the terms “artificial grass” and “artificial turf” may be used interchangeably, but in any instance, the use of either term is intended to refer to similar types of structures and/or systems.

The object of the invention is achieved by a fabric comprising:
first and second fabric layers comprising non-shrinkable yarns in the warp direction;
third and fourth fabric layers comprising shrinkable yarns in the warp direction; wherein
the first and second fabric layers are sandwiched between the third and fourth fabric layers, wherein
the first and second fabric layers zigzag between the third and fourth layers and are alternatingly connected to the third and fourth layer, and wherein
the first and second zigzagging fabric layers are shifted relatively to each other over half a phase and are intertwined with each other.

Such a fabric provides an open structure as a result of the zigzagging fabric layers sandwiched between the first and second fabric layers. Such a fabric is very useful in artificial grass systems as the fabric provides for a tubular-shaped open structure after heating of the fabric, which has shock absorbency, provides improved drainage, energy restitution and has dimensional stability. Although this fabric according to the invention is developed based on requirements for artificial grass systems, the fabric may also be used for other applications in which a layer is necessary with similar advantages.

Embodiments of the invention can provide methods and systems for providing an artificial grass system with improved drainage, shock absorbency, load displacement, energy restitution and dimensional stability. One embodiment of the invention can provide an artificial grass system with a woven tubular-shaped fabric and tufted artificial turf yarn. The fabric of the invention has in this case woven fabric layers. The fabric can function as both a primary backing or substrate and as a sub-base for an artificial grass system. For example, the fabric according to the invention can be made from at least two types of yarn with different shrink characteristics. One type of yarn may have a relatively high shrink characteristic, such as polyethylene yarns while the other type of yarn may have a relatively low or no shrink characteristic, such as a polypropylene or polyester yarn. The yarns can be woven or otherwise fixed together to form an essentially flat structure, and then tufted with a face yarn. A face yarn can be an artificial turf yarn or other similar type yarn. These face yarns can comprise polypropylene, polyethylene, nylon, polyester, block co-polymers or mixtures of these and other polymers. The woven yarns with the face yarn can collectively be heated to shrink the relatively high shrink yarn and cause some or all of the yarns to increase in density and form a tubular-shaped fabric. In some instances, additional face yarns can be tufted into the woven tubular-shaped fabric with tufting needles capable of penetrating the tubular-shaped fabric. In any instance, the woven tubular-shaped fabric can provide the face yarn with one or more intermittent points of contact to stabilize the face yarn in a desired position, such as an upright position for stability. The combination of the tubular-shaped fabric and tufted artificial turf yarn can provide compressive resistivity to permit loads to be dispersed, thereby reducing load impact on the artificial grass system. Furthermore, the combination can provide multiple spaces, interstices, channels within the artificial grass system and thereby improve moisture and water drainage characteristics.

The invention also relates to a method for manufacturing a tubular-shaped fabric comprising the steps:
providing a fabric according to the invention wherein the shrinkable yarns are heat shrinkable,
heating the fabric to a temperature such that the yarns of the third and fourth layer shrink, while the first and second layers are virtually not affected, such that the zigzagging, intertwined first and second layer are urged to adopt a tubular structure with a longitudinal axis in weft direction.

By heating the shrinkable yarns, the length of the first and second fabric layer will decrease. The length of the third and fourth layer will remain constant, as this layer is made of non-shrinkable yarns. As a result the extra length has to be compensated. As the third and fourth layer are already zigzagging, the non-shrinkable yarns will start to curve and as the first and second zigzagging layers are shifted over half a phase, tubular structures will be formed. These tubular structures are inherently strong as a result of the shape and can provide the desired shock absorbency. Also the tubular structure provides channels within the fabric which improves the drainage.

In a further embodiment of the method according to the invention, the fabric is tufted with a face yarn before the fabric is heated to shrink the yarns. As the fabric is heated and the tubular structure will take shape, the face yarns will extend over the full thickness of the fabric and as a result the face yarns are kept perpendicular to the fabric and cannot tilt other than by bending. It would also be possible to first shrink the yarns and then tuft the fabric with face yarns.

Preferably, the face yarns are grass-like, such that an artificial grass system can be provided.

The invention also relates to an artificial grass or turf system comprising:
a tubular-shaped fabric manufactured according to the invention as a base layer;
a backing layer arranged on top of the base layer; wherein the backing layer is tufted with face yarns.

In this artificial grass system according to the invention, the tubular-shaped fabric is used as a shock absorbency layer having improved drainage on top of which a conventional artificial grass system can be arranged.

### BRIEF DESCRIPTION OF THE DRAWINGS

FIG. 1 shows a schematic cross-sectional view of an artificial grass system according to one embodiment of the invention.

FIG. 2 is a perspective view of an artificial grass system according to an embodiment of the present invention.

FIG. 3 is another perspective view of the artificial grass system shown in FIG. 2.

FIG. 4 is a side elevation view of the artificial grass system shown in FIGS. 2 and 3.

FIG. 5 is another perspective view of the artificial grass system shown in FIGS. 2-4.

### DETAILED DESCRIPTION

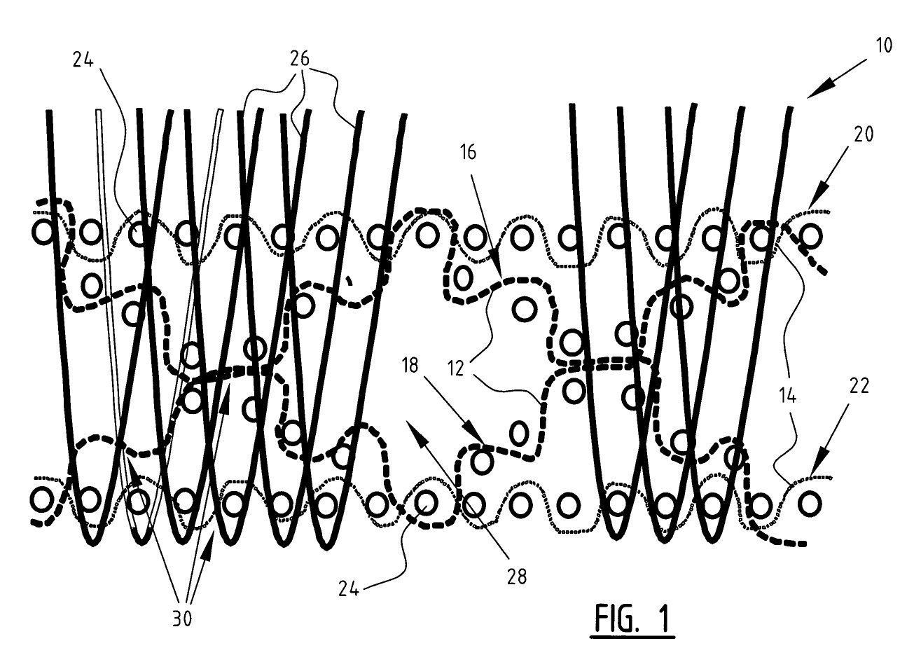

Referring initially to FIG. 1, a diagram of an artificial grass system 10 is illustrated according to one embodiment of the invention. The artificial grass system 10 can include at least two layers of two different types of yarn 12, 14 positioned in the warp direction. The first yarn 12 can be a non-shrink or relatively low shrink yarn. Examples of a first yarn can be, but are not limited to, polyethylene yarn, polyester yarn or any other suitable non-shrink or no-shrink yarn. The first yarn 12 can be used to form a woven fabric used as a first layer 16 and second layer 18 for an artificial grass system 10.

The first layer 16 and second layer 18 are positioned adjacent to each other and sandwiched between an upper or third layer 20, and a lower or fourth layer 22. Other embodiments of the invention can utilize other arrangements or combinations of layers.

The second yarn 14 can be a relatively high shrink yarn. Examples of a second yarn can be, but are not limited to, a polyethylene yarn or any other suitable high shrink yarn. The second yarn can be used to form a woven fabric used as the third layer 20 and the fourth layer 22 for an artificial grass system 10.

The first layer 16 and second layer 18 can be woven together with one or more pick or fill yarns 24. The third layer 20 and fourth layer 22 can sandwich the first 16 and second 18 layers and all the layers can be woven together with one or more pick or fill yarns 24, or otherwise adhered together, to form a relatively flat structure. The pick or fill yarns 24 can be located in the weft direction, and can provide a supporting membrane for the yarns 12, 14 comprising the first, second, third, and fourth layers (16, 18, 20, 22). Face yarns 26 can be tufted into the woven structure by any suitable tufting method or device. The pick or fill yarns 24 can provide support for the face yarns 26. Pick or fill yarns 24 may be any suitable type of yarn preferably, but not necessarily, having low shrink characteristics. Examples of a fill or pick yarn can be, but are not limited to, polypropylene, polyethylene, nylon and polyester. The fill yarns can be monofilament, tape, spun or continuous filament yarns. Examples of a face yarn can be, but are not limited to, polypropylene, polyethylene, nylon and polyester. The warp yarns 12, 14 and fill yarns 24 can also be bi-component, monofilament, tape, spun, twisted, multifilament yarns or any combination thereof to provide desired end use performance characteristics.

The woven tufted structure can be heated to a suitable temperature, causing the second yarns 14 of the third layer 20 and fourth layer 22 to shrink. The shrinkage of the second yarns 14 of the third layer 20 and fourth layer 22 causes the first layer 16 and second layer 18 to deflect between the third layer 20 and fourth layer 22, thereby increasing the density of the overall structure and causing the first layer 16 and second layer 18 to form multiple tubular structures 28.

The face yarns 26 can be supported by the woven tufted structure, in particular by multiple points 30 of contact with the tubular structures 28. In this manner, the face yarns 26 can be stabilized and positioned in an upright position relative to the tubular structures 28 and woven tufted structure. The resulting woven tufted structure with tubular structures 28 and associated face yarns 26 can be used as an artificial grass system 10, or component thereof, capable of providing a desirable shock absorbent, load displacement, soil reinforcement, and drainage characteristics. The tubular structures 28 provide channels for water to drain through the artificial grass system 10 and allow the artificial grass system to be compressed, thereby providing desirable shock absorbency characteristics.

While the face yarns 26 have been described as being tufted into the woven structure prior to heating, one of skill in the art will understand that the woven structure can be heated to form the tubular structure 28 prior to tufting.

In other embodiments of the invention, one or more characteristics, such as shock absorbency, load displacement, soil reinforcement, energy restitution, drainage, and size, of the artificial grass system 10, can be altered, as desired, by manipulating the types of yarn such as 12, 14 and/or varying the heating temperatures and dwell times to cause the various yarns to shrink. For example, the first and second yarns such as 12, 14 can be made from other types of suitable polymers that provide different shrink characteristics that, after heating, may result in an artificial grass system with a thickness of approximately 20 millimeters. In another embodiment, an artificial turf system can be made with suitable polymers that provide different shrink characteristics that, after heating, may result in an artificial grass system with a thickness of approximately 100 millimeters. Other embodiments of an artificial turf system can be made with suitable polymers that provide different shrink characteristics that, after heating, may result in an artificial grass system with any thickness between 20 to 100 millimeters.

In addition, other embodiments of the invention can utilize different heating temperatures, dwell times, and alternative types of heating processes to manipulate and obtain desired characteristics of an artificial grass system such as 10. For example, the woven tufted structure of an artificial grass system, such as 10, can be heated using a hot air oven or an infrared heating process, between 150° Fahrenheit to 400° Fahrenheit at ambient pressure for ten seconds up to approximately five minutes.

As needed, the embodiment described above in FIG. 1 can be utilized with other layers, materials, and fabrics to provide a suitable field with artificial turf or grass.

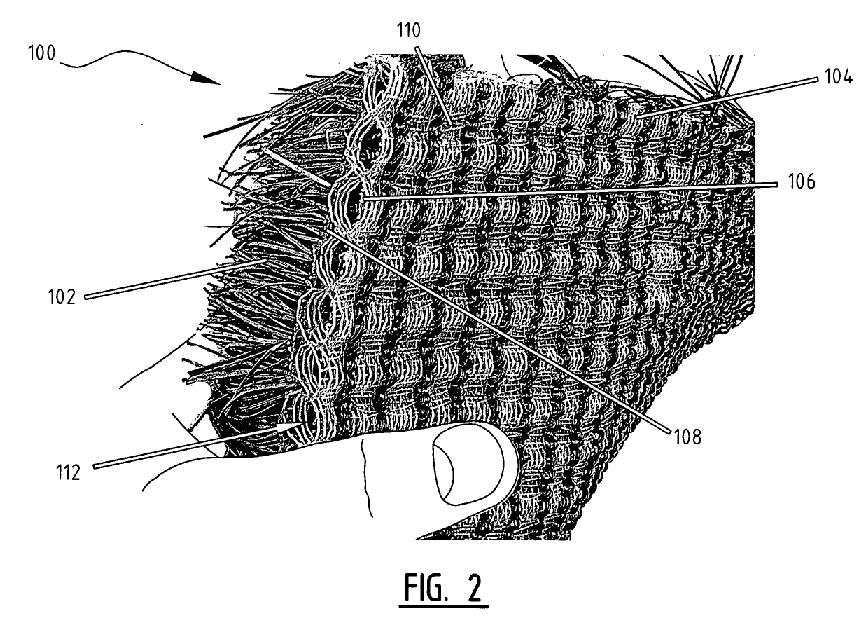

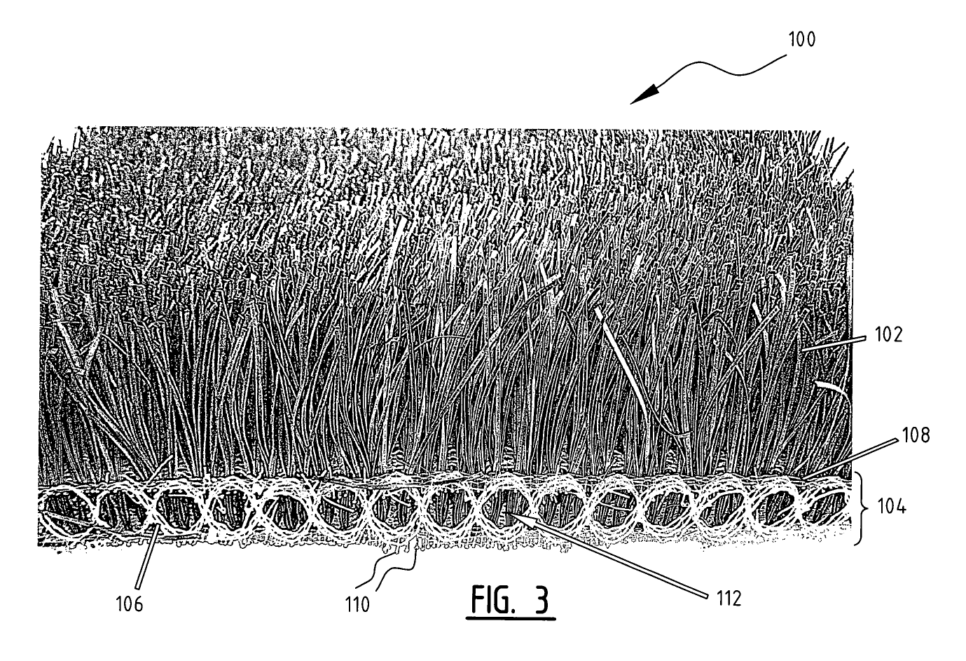

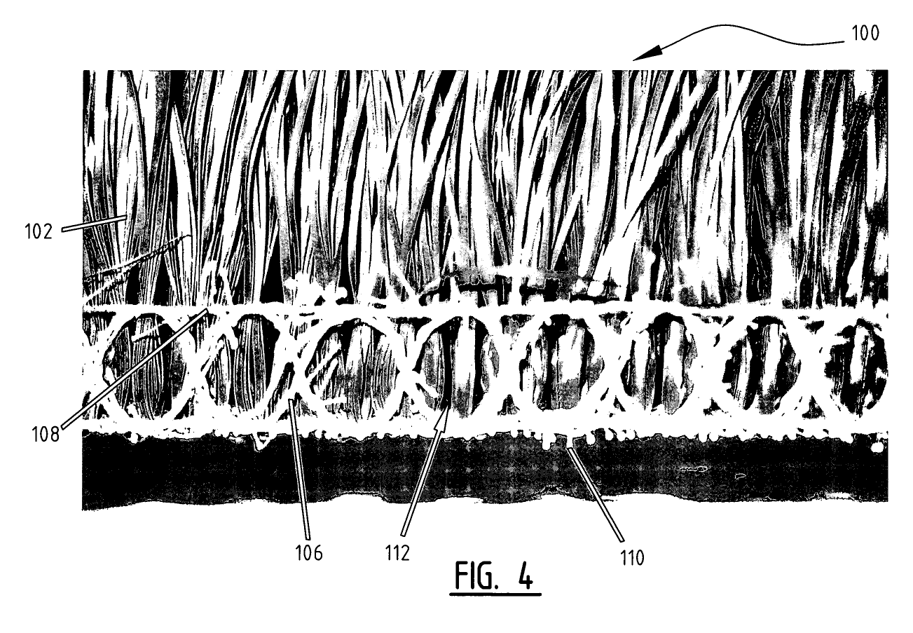

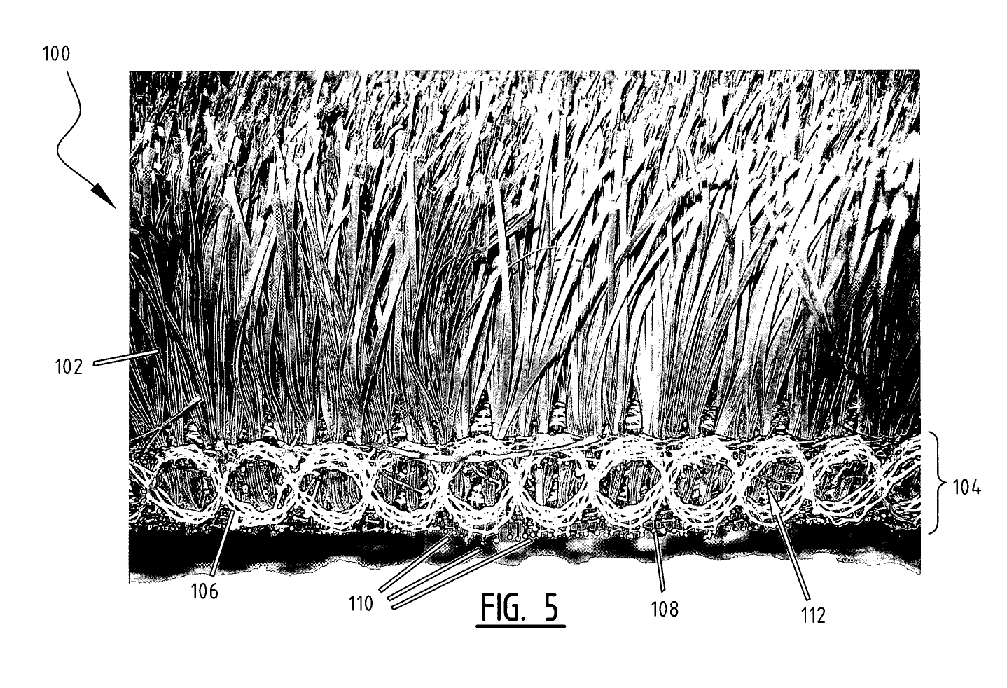

Referring now to FIGS. 2-5, an artificial turf system 100 according to an embodiment of the invention is shown with artificial turf yarns 102 tufted through a woven structure 104. The woven structure shown can be made from at least two types of yarn 106, 108 positioned in the warp direction, and pick or fill yarns 110 positioned in the weft direction. The two types of yarn 106, 108 shown can have different shrink characteristics such that at least one type of yarn shrinks when heat is applied to the woven structure. The artificial turf yarn 102 can be tufted into the woven structure prior to applying heat. As shown in FIGS. 2-5, after heating, the woven yarns form a tubular-shaped structure 112 that supports the tufted artificial turf yarn 102 in a relatively upright position approximately 90 degrees relative to the tubular-shaped structure 112. The resulting artificial grass system 100 can provide improved shock absorbency, load displacement, soil reinforcement, energy restitution and drainage characteristics for an artificial grass or turf system.

The systems, structures, and processes described above illustrate exemplary embodiments of inventive concepts included in the invention. Other systems, structures, and processes are possible. While the invention has been described in detail with particular references to these particular embodiments, variations and modifications can be affected within the spirit and scope of the invention as described in this document. For example, the techniques of the present invention may also be used with other types of suitable fibers, materials, or fabrics.

With the artificial grass system according to the invention tests were performed according to the “Artificial Athlete” method according to the FIFA quality concept “Handbook of Test methods for Football Turf” (March 2006 edition).

The construction of the artificial grass system according to the invention is as follows:

Carpet Details

| | | |
|---|---|---|
| Stichrate | 17 | stitches/10 cm |
| Gauge | ¾ | inch |
| Number of Stiches | 8924 | stitches/m² |
| Pileheight | 62 | mm |

| | |
|---|---|
| | 12 mm of the length is into the |
| | fabric according invention |
| Face Yarn | 11000 dtex, 6-ply monofilament |
| Face Yarn weight: | 1300 g/m² in fabric according the invention |

Fabric Details According Invention

| Weight fabric before heat treatment | 390 | g/m² |
|---|---|---|
| Weight fabric after heat treatment | 550 | g/m² |
| Shrinkage factor approximately | 40% | |
| Thickness fabric | 12 | mm |

First layer 16 and second layer 18 are polypropylene monofilament yarns with low or almost zero shrinkage factor at 115° C.

Third layer 20 and fourth layer 22 are polyethylene yarns with high shrinkage levels at 115° C.

As reference material a conventional artificial grass system is used having the following details:

Carpet Details

| | | |
|---|---|---|
| Stichrate | 17 | stitches/10 cm |
| Gauge | ¾ | inch |
| Number of Stiches | 8924 | stitches/m² |

| | |
|---|---|
| Pileheight | 50 mm in flat fabric |
| Face Yarn | 11000 dtex, 6-ply monofilament |
| Face Yarn weight: | 1060 g/m² in flatfabric |

Flatfabric:

Multilayer of 2 woven fabrics needled together.

Fabric weight 265 g/m²

Fabrics are woven with polypropylene tape yarns.

The testing was performed with the “Artificial Athlete” according to FIFA Test method 04 (Determination of shock absorption). The test results are as follows:

| | with 10 mm Rubber | without Infill |
|---|---|---|
| Shock Absorption | SBR Infill % | % |
| Fabric according to invention | 56.2 | 39.3 |
| flat conventional fabric | 35.1 | 18.5 |

It is clear from the test results, that the artificial grass system according to the invention has a better shock absorption than the conventional artificial grass system. It is clear that with less rubber infill it is possible to get a desired level of shock absorption.

1-13. (canceled)

14. A fabric comprising:
(a) first and second fabric layers comprising nonshrinkable yarns in a warp direction; and
(b) third and fourth fabric layers comprising shrinkable yarns in the warp direction; wherein
(i) the first and second fabric layers are sandwiched between the third and fourth fabric layers,
(ii) the first and second fabric layers zigzag between the third and fourth layers and are alternatingly connected to the third and fourth layer, and
(iii) the first and second zigzagging fabric layers are shifted relatively to each other over half a phase and are intertwined with each other.

15. The fabric according to claim 14, wherein the fabric layers are woven layers.

16. The fabric according to claim 14, wherein the nonshrinkable yarns comprise polypropylene or polyester.

17. The fabric according to claim 14, wherein the shrinkable yarns comprise polyethylene.

18. The fabric according to claim 14, further comprising face yarns arranged to at least one of the fabric layers.

19. The fabric according to claim 18, wherein the face yarns are arranged by tufting.

20. The fabric according to claim 19, wherein the face yarns extend through all fabric layers.

21. The fabric according to claim 18, wherein the face yarns comprise polypropylene, polyethylene, nylon or polyester, block co-polymers or mixtures of these and other polymers.

22. The fabric according to claim 18, wherein the fabric layers are attached to each other by one or more pick or fill yarns.

23. A method for manufacturing a tubular-shaped fabric, comprising the steps of:
(a) providing a fabric according to claim 18, wherein the shrinkable yarns are heat shrinkable, and
(b) heating the fabric to a temperature such that the yarns of the third and fourth layer shrink, while the first and second layers are virtually not affected, such that the zigzagging, intertwined first and second layer are urged to adopt a tubular structure with a longitudinal axis in a weft direction.

24. The method according to claim 23, wherein the fabric is tufted with a face yarn before the fabric is heated to shrink the yarns.

25. An artificial grass or turf system, comprising a tubular-shaped fabric manufactured according to claim 23, having grass like face yarns.

26. An artificial grass or turf system, comprising:
a tubular-shaped fabric manufactured according to claim 23 as a base layer; and
a backing layer arranged on top of the base layer;
wherein the backing layer is tufted with face yarns.
